(19) United States
(12) Patent Application Publication
(10) Pub. No.: US 2005/0170251 A1
(43) Pub. Date: Aug. 4, 2005

(54) Positive electrode for lithium secondary battery and lithium secondary battery comprising the same

(76) Inventors: Won-II Jung, Suwon-si (KR); Yong-Chul Park, Suwon-si (KR); Geun-Bae Kim, Suwon-si (KR); Jun-Won Suh, Suwon-si (KR)

Correspondence Address: CHRISTIE, PARKER & HALE, LLP, PO BOX 7068, PASADENA, CA, 91109-7068, US

(21) Appl. No.: 10/992,345

(22) Filed: Nov. 17, 2004

(30) Foreign Application Priority Data
Nov. 20, 2003 (KR) 10-2003-0082429

(51) Int. Cl. H01M 4/62; H01M 4/58; H01M 4/52; H01M 4/50

(52) U.S. Cl. 429/232; 429/223; 429/231.1; 429/224; 429/231.95

(57) ABSTRACT

Provided is a positive electrode for a lithium secondary battery including a positive active material and a conductive agent comprising a plurality of plate-structured carbon particles.

### CROSS REFERENCE TO RELATED APPLICATION

This application claims priority to and is based on Korean Patent Application No. 10-2003-0082429 filed in the Korean Intellectual Property Office on Nov. 20, 2003, the entire disclosure of which is incorporated hereinto by reference.

### FIELD OF THE INVENTION

The present invention relates to a positive electrode for a lithium secondary battery and a lithium secondary battery comprising the same; and, more particularly, to a positive electrode for a lithium secondary battery with an increased active mass density and a lithium secondary battery comprising such a positive electrode.

### BACKGROUND OF THE INVENTION

Recent developments in the high-tech electronic industry have allowed miniaturized and lightweight electronic equipment, which has led to increased use of portable electronic equipment. As a power source for the portable electronic equipment, there is a growing need for batteries with high energy density, and there is much research activity into lithium secondary batteries.

Materials capable of reversibly intercalating or deintercalating lithium ions are used as the active materials in positive and negative electrodes for lithium secondary batteries. A lithium secondary battery generally includes a positive electrode, a negative electrode, and an organic electrolyte or a polymer electrolyte presented between the positive electrode and the negative electrode. Electric energy is generated based on the oxidation and reduction reactions when lithium ions are intercalated or deintercalated into or from the positive and negative electrodes.

Lithium metal is often used as a negative active material for a lithium secondary battery. However, the use of lithium metal can cause short circuits in the battery due to the formation of dendrites, and such short circuits may cause the battery to explode. Therefore, lithium metal is gradually being replaced with carbon-based materials such as amorphous carbon and crystalline carbon.

The positive active material chiefly contributes to the performance and safety of lithium secondary batteries. Chalcogenide compounds are often used as the positive active materials, and exemplary thereof are composite metal oxides such as LiCoO₂, LiMn₂O₄, LiNiO₂, LiNi₁₋ₓCoₓO₂ (where 0<x<1), and LiMnO₂.

Among the various positive active materials that are used, manganese-based positive active materials such as LiMn₂O₄ and LiMnO₂ are attractive in that they can be synthesized easily, they are relatively cheap, and they cause less pollution to the environment. However, they have a shortcoming in that the capacity thereof is small. Cobalt-based positive active materials such as LiCoO₂ have fine electric conductivity, they bring about a high battery voltage, and have excellent electrode characteristics, but they also have a problem in that their production cost is high. Nickel-based positive active materials such as LiNiO₂ generally present a battery with the cheapest production cost and the highest discharge capacity among the above-mentioned positive active materials. However, such materials can be difficult to synthesize.

Among the above-mentioned positive active materials, cobalt-based active materials have been mainly used for a positive active material, but recently nickel-based positive active materials having a large capacity have been actively studied to develop batteries with a higher capacity than is realized for existing batteries. However, since the nickel-based positive active materials have a globular shape, the maximum density of an active mass of a positive active material, a binder, and a conductive agent in the fabrication of an electrode is generally no more than 3.2 g/cc. Often, such a conductive agent is rolled to raise the active mass density during the fabrication of the electrode. Using such methods, an electrode with a high active mass density is formed as active material particles are pressed and slide by the pressure from the rolling process. However, since the nickel-based positive active materials have a low hardness, their particles tend to break rather than slide. Therefore, the active mass density cannot be increased further. For this reason, although the material have a theoretically high capacity, it is difficult to obtain a high-capacity battery in practice due to the low active mass density.

To overcome this problem, a recent study has suggested a method of mixing a shapeless cobalt-based positive active material and a nickel-based positive active material to obtain a high active mass density. The method, however, degrades the effect of obtaining a large capacity by raising the active mass density because the capacity of the shapeless cobalt-based positive active material is too low.

### SUMMARY OF THE INVENTION

In one embodiment of the present invention, a positive electrode for a lithium secondary battery having a high active mass density is provided.

In another embodiment of the present invention a lithium secondary battery having the positive electrode is provided.

An embodiment of the present invention provides a positive electrode for a lithium secondary battery including a positive active material and a plate-structured carbon conductive agent. Preferably, the positive active material is prepared through a wet process, and examples of the positive active materials prepared through the wet process include nickel-based positive active materials and manganese-based positive active materials.

In another embodiment of the present invention, a lithium secondary battery is provided that includes a positive electrode with the positive active material; a negative electrode having a negative active material capable of intercalating and deintercalating lithium ions; and an electrolyte.

### BRIEF DESCRIPTION OF THE DRAWINGS

The above and other objects and features of various embodiments of the present invention will become apparent from the following description of certain preferred embodiments given in conjunction with the accompanying drawings, in which:

FIG. 1 is a perspective view showing the structure of a lithium secondary battery in accordance with an embodiment of the present invention; and

FIG. 2 is a perspective view showing the plate structure used as a conductive agent.

### DETAILED DESCRIPTION

Other objects and aspects of the invention will become apparent from the following description of certain embodiments with reference to the accompanying drawings, which is set forth hereinafter.

A conductive agent in the present invention includes plate-structured carbon. Therefore, if it is used with a globular positive active material such as a nickel-based positive active material or a manganese-based positive active material that is prepared through a wet process to form the positive electrode, the positive active material is pressed and slides during a rolling process of the positive electrode fabrication process. Therefore, the active mass density can be increased.

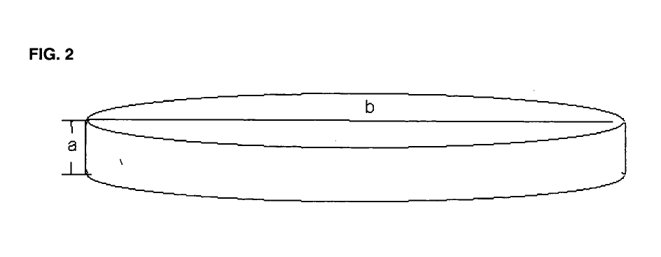

In the present specification, the term “plate structure” means something that the material has a generally planar shape as shown in FIG. 2 in which such a plate structure includes a short axis (a) and a long axis (b).

The plate-structured carbon conductive agent preferably has a long-to-short axis ratio of from 1 to 10:1. If the ratio of the long axis to the short axis is more than 10, the conductive agent may be broken, which is undesirable. The plate-structured carbon conductive agent preferably has a granularity of 1 to 10 μm. If the granularity of the plate-structured carbon conductive agent is less than 1 μm, which is sub-micron size, the particles of the conductive agent are too small to form the plate structure and the sliding effect does not occur, which is undesirable as well. A plate-structured carbon conductive agent within these parameters has high tap density.

A plate-structured carbon material of a crystalline or some other structure may be used as long as it has a plate structure. Crystalline carbon, however, is preferred, and particularly, natural graphite tends to yield better results compared to artificial graphite.

The conductive agent of the present invention is preferably used for the positive electrode of the lithium secondary battery. To be specific, it is used for a positive electrode using a nickel-based or manganese-based positive active material that is prepared according to a wet process. For the nickel-based positive active material, any one of the compounds represented by formulae 1 to 7 below can be used, and for the manganese-based positive active material, any one of the compounds represented by formulae 8 to 12 can be used:
LiₓNi_{1-y}M_{y}A₂ (1);
LiₓNi_{1-y}M_{y}O_{2-z}X_{z} (2);
LiₓNi_{1-y}Co_{y}O_{2-z}X_{z} (3);
LiₓNi_{1-y-z}Co_{y}M_{z}Aₐ (4);
LiₓNi_{1-y-z}Co_{y}M_{z}O₂-aXₐ (5);
LiₓNi_{1-y-z}Mn_{y}M_{z}Aₐ (6);
and
LiₓNi_{1-y-z}Mn_{y}M_{z}O₂₋ₐXₐ (7)
where 0.90≦x≦1.1, 0≦y≦0.5, 0≦z≦0.5, and 0≦a≦2; M is at least one element selected from the group consisting of Al, Ni, Co, Mn, Cr, Fe, Mg, Sr, V and rare-earth elements; A is an element selected from the group consisting of O, F, S and P; and X is an element selected from the group consisting of F, S and P.
   LiₓMn_{1-y}M₁A₂ (8);
   LiₓMn_{1-y}M_{y}O_{2-z}X_{z} (9);
   LiₓMn₂O_{4-z}X_{z} (10);
   LiₓCo_{1-y}M_{y}A₂ (11);
   and
   LiₓCo_{1-y}M_{y}O_{2-z}X_{z} (12)
where 0.90≦x≦1.1, 0≦y≦0.5, 0≦z≦0.5, and 0≦a≦2; M is at least one element selected from the group consisting of Al, Ni, Co, Mn, Cr, Fe, Mg, Sr, V and rare-earth elements; A is an element selected from the group consisting of O, F, S and P; and X is and element selected from the group consisting of F, S and P.

In addition, the nickel-based or manganese-based positive active material is formed of secondary particles, each of which is formed by agglomerating primary particles.

In addition, a cobalt-based positive active material can be mixed with the nickel-based or manganese-based positive active material, and may also used as a positive active material in the present invention.

The positive electrode having the conductive agent of the present invention includes a binder for attaching a positive active material and the conductive agent to a current collector. Any binder that is generally used for a lithium secondary battery can be used in the present invention. Examples include polyvinylidene fluoride, polytetrafluoroethylene, polyvinylchloride, and polyvinylpyrrolidone.

The active mass density of the positive electrode in a lithium secondary battery using the conductive agent of the present invention is about 3.28 g/cc, which is higher than that of a lithium secondary battery using a conventional conductive agent, i.e., around 3.20 g/cc.

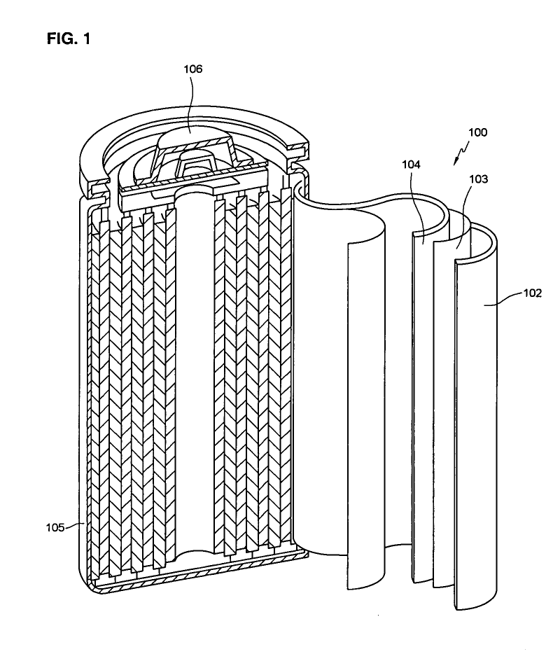

FIG. 1 shows an example of a lithium secondary battery having a positive electrode including the conductive agent suggested in the present invention. As shown in FIG. 1, the lithium secondary battery of the present invention includes a positive electrode 102; a negative electrode 104; a separator 103 between the positive electrode and the negative electrode; an electrolyte in which the negative and positive electrodes and the separator are immersed in a cylindrical battery container 105; and a sealing material 106 for sealing the battery container. Although FIG. 1 presents a cylindrical battery, the lithium secondary battery of the present invention is not limited to those of a cylindrical shape, but rather, can be embodied in any other shape including a polygonal shape, a pouch shape or other shapes.

The negative active material includes a material that can reversibly intercalate and deintercalate lithium ions, or a material that reversibly reacts with lithium ions to form a lithium-containing compound. Examples of such materials include carbon-based materials such as crystalline carbon, amorphous carbon, or carbon composite. Examples of materials that reversibly react with lithium ions to form a lithium-containing compound include tin oxide (SnO2), titanium nitrate, silicon (Si), and the like. However, the invention is, not limited to the aforementioned examples. For a lithium alloy, an alloy of lithium and a metal selected from the group consisting of Na, K, Rb, Cs, Fr, Be, Mg, Ca, Sr, Ba, Ra, Al and Sn can be used.

The electrolyte includes a lithium salt and a non-aqueous organic solvent. The lithium salt is dissolved in the organic solvent and becomes a source of lithium ions in the battery to thereby let the lithium secondary battery perform its basic function, and to promote the transfer of lithium ions between the positive and negative electrodes. The lithium salt includes at least one compound selected from LiPF₆, LiBF₄, LiSbF₆, LiAsF₆, LiCF₃SO₃, LiN(CF₃SO₂), Li(CF₃SO₂)₂N, LiC₄F₉SO₃, LiClO₄, LiAlO₄, LiAlCl₄, LiN(CₓF₂ₓ₊₁SO₂)(C_{y}F_{2y+1}SO₂) wherein x and y are natural numbers, and LiCl, and LiI as a supporting electrolytic salt. The concentration of the lithium salt is preferably in the range of 0.6 to 2.0M. If the concentration of the lithium salt is lower than 0.6M, the conductivity of the electrolyte is decreased and thus the performance of the electrolyte is degraded. If the concentration of the lithium salt is higher than 2.0M, the viscosity of the electrolyte is increased and the mobility of the lithium ions is undesirably reduced.

The non-aqueous organic solvent acts as a medium through which ions involved in the electrochemical reaction of the battery can be transferred. For the non-aqueous organic solvent, at least one compound selected from the group consisting of carbonates, esters, ethers and ketones can be used. For carbonates, cyclic carbonates or chain carbonates can be used. If two or more organic solvents are mixed and used, the mixing ratio can be adjusted appropriately based on the desired battery performance and this can be easily understood by those skilled in the art. For cyclic carbonates, at least one selected from the group consisting of ethylene carbonate, and propylene carbonate can be used. For chain carbonates, at least one selected from the group consisting of dimethyl carbonate, diethyl carbonate, ethylmethyl carbonate, and methylpropyl carbonate can be used. For esters, y-butyrolactone, valerolactone, decanolide, mevalolactone and the like can be used. For ketones, polymethylvinyl ketone and the like can be used.

Hereinafter, the following examples and comparative examples illustrate the present invention in further detail. However, it is understood that the examples are for illustration only, and that the present invention is not limited to these examples.

### EXAMPLE 1

A LiNiO₂ positive active material, a polyvinylidene fluoride binder and a plate-structured natural graphite conductive agent (average diameter: 3 μm, long axis: approximately 5 μm, short axis: approximately 1 μm, trade mark: DJG-NEW 2, SODIFF Co. Ltd., with a long-to-short axis ratio of 8:1) were mixed in a weight ratio of 94:3:3 in an N-methylpyrrolidone organic solvent to thereby prepare a positive active material composition.

Subsequently, the positive active material composition was coated on an aluminum foil current collector, dried, and then pressed to thereby produce a positive electrode.

### COMPARATIVE EXAMPLE 1

A positive electrode was produced by the same process as in Example 1, except that the conductive agent was replaced with globular carbon black.

The active mass densities of the positive electrodes according to Example 1 and Comparative Example 1 were measured. The active mass density of the positive electrode according to Example 1 was 3.28 g/cc which was higher than that of Comparative Example 1 which was 3.20 g/cc.

As described above, the present invention can improve the active mass density of a positive electrode by using a plate-structured conductive agent.

While the present invention has been described with respect to certain preferred embodiments, it will be apparent to those skilled in the art that various changes and modifications may be made without departing from the scope of the invention as defined in the following claims.

1. A positive electrode for a lithium secondary battery, comprising:
a positive active material; and
a conductive agent comprising a plurality of plate-structured carbon particles.

2. The positive electrode as recited in claim 1, wherein the positive active material is selected from the group consisting of nickel-based positive active materials and manganese-based positive active materials.

3. The positive electrode as recited in claim 2, wherein the nickel-based positive active material is selected from the group consisting of compounds of formulae (1) to (7):
LiₓNi_{1-y}M_{y}A₂ (1);
LiₓNi_{1-y}M_{y}O_{2-z}X_{z} (2);
LiₓNi_{1-y}Co_{y}O_{2-z}X_{z} (3);
LiₓNi_{1-y-z}Co_{y}M_{z}Aₐ (4);
LiₓNi_{1-y-z}Co_{y}M_{z}O₂₋ₐXₐ (5);
LiₓNi_{1-y-z}Mn_{y}M_{z}Aₐ (6);
and
LiₓNi_{1-y-z}Mn_{y}M_{z}O₂₋ₐXₐ (7)
wherein 0.90≦x≦1.1, 0≦y≦0.5, 0≦z≦0.5, and 0≦a≦2;
M is selected from the group consisting of Al, Ni, Co, Mn, Cr, Fe, Mg, Sr, V, rare-earth elements and combinations thereof;
A is selected from the group consisting of O, F, S, and P; and
X is selected from the group consisting of F, S, and P, and
the manganese-based positive active material is selected from the group consisting of compounds of formulae (8) to (12):
LiₓMn_{1-y}M_{y}A₂ (8);
LiₓMn_{1-y}M_{y}O_{2-z}X_{z} (9);
LiₓMn₂O_{4-z}X_{z} (10);
LiₓCo_{1-y}M_{y}A₂ (11);
and
LiₓCo_{1-y}M_{y}O_{2-z}X_{z} (12)
wherein 0.90≦x≦1.1, 0≦y≦0.5, 0≦z≦0.5, and 0≦a≦2;
M is selected from the group consisting of Al, Ni, Co, Mn, Cr, Fe, Mg, Sr, V, rare-earth elements and combinations thereof;
A is selected from the group consisting of O, F, S, and P; and
X is selected from the group consisting of F, S, and P.

4. The positive electrode as recited in claim 2, wherein the positive active material further comprises a cobalt-based positive active material.

5. The positive electrode as recited in claim 3, wherein the nickel-based positive active material or the manganese-based positive active material is provided as a plurality of primary particles, wherein the positive electrode further comprises a plurality of secondary particles, formed by agglomerating the primary particles.

6. The positive electrode as recited in claim 1, wherein the plurality of plate-structured carbon particles each include a long axis and a short axis and the ratio of the long axis to the short axis is between 1 and 10:1.

7. The positive electrode as recited in claim 1, wherein the conductive agent is natural graphite.

8. A lithium secondary battery, comprising:
a positive electrode including a positive active material and a conductive agent comprising a plurality of plate-structured particles;
a negative electrode capable of intercalating and deintercalating lithium ions; and
an electrolyte.

9. The lithium secondary battery as recited in claim 8, wherein the plurality of plate-structured particles each include a long axis and a short axis and the ratio of the long axis to the short axis is between 1 and 10:1.

10. The lithium secondary battery as recited in claim 8, wherein the positive active material is selected from the group consisting of nickel-based positive active materials and manganese-based positive active materials.

11. The lithium secondary battery as recited in claim 10, wherein the nickel-based positive active material is selected from the group consisting of compounds of formulae (1) to (7):
LiₓNi_{1-y}M_{y}A₂ (1);
LiₓNi_{1-y}M_{y}O_{2-z}X_{z} (2);
LiₓNi_{1-y}Co_{y}O_{2-z}X_{z} (3);
LiₓNi_{1-y-z}Co_{y}M_{z}Aₐ (4);
LiₓNi_{1-y-z}Co_{y}M_{z}O₂₋ₐXₐ (5);
LiₓNi_{1-y-z}Mn_{y}M_{z}Aₐ (6);
and
LiₓNi_{1-y-z}Mn_{y}M_{z}O₂₋ₐXₐ (7)
wherein 0.90≦x≦1.1, 0≦y≦0.5, 0≦z≦0.5, and 0≦a≦2;
M is selected from the group consisting of Al, Ni, Co, Mn, Cr, Fe, Mg, Sr, V, rare-earth elements and combinations thereof;
A is selected from the group consisting of O, F, S, and P; and
X is selected from the group consisting of F, S, and P, and
the manganese-based positive active material is selected from the group consisting of compounds of formulae (8) to (12):
LiₓMn_{1-y}M_{y}A₂ (8);
LiₓMn_{1-y}M_{y}O_{2-z}X_{z} (9);
LiₓMn₂O_{4-z}X_{z} (10);
LiₓCo_{1-y}M_{y}A₂ (11);
and
LiₓCo_{1-y}M_{y}O_{2-z}X_{z} (12)
wherein 0.90≦x≦1.1, 0≦y≦0.5, 0≦z≦0.5, and 0≦a≦2;
M is selected from the group consisting of Al, Ni, Co, Mn, Cr, Fe, Mg, Sr, V, rare-earth elements and combinations thereof;
A is selected from the group consisting of O, F, S, and P; and
X is selected from the group consisting of F, S, and P.

12. The lithium secondary battery as recited in claim 10, wherein the positive active material further comprises a cobalt-based positive active material.

13. The lithium secondary battery as recited in claim 10, wherein the nickel-based positive active material or the manganese-based positive active material is provided as a plurality of primary particles, wherein the positive electrode further comprises a plurality of secondary particles, formed by agglomerating the primary particles.

14. A lithium secondary battery, comprising:
a positive electrode including a nickel-based positive active material and a conductive agent comprising a plurality of plate-structured particles;
a negative electrode capable of intercalating and deintercalating lithium ions; and
an electrolyte.

15. The lithium secondary battery as recited in claim 14, wherein the plurality of plate-structured particles each include a long axis and a short axis and the ratio of the long axis to the short axis is between 1 and 10:1

16. The lithium secondary battery as recited in claim 14, wherein the nickel-based positive active material is selected from the group consisting of compounds of formulae (1) to (7):
LiₓNi_{1-y}M_{y}A₂ (1);
LiₓNi_{1-y}M_{y}O_{2-z}X_{z} (2);
LiₓNi_{1-y}Co_{y}O_{2-z}X_{z} (3);
LiₓNi_{1-y-z}Co_{y}M_{z}Aₐ (4);
LiₓNi_{1-y-z}Co_{y}M_{z}O₂₋ₐXₐ (5);
LiₓNi_{1-y-z}Mn_{y}M_{z}Aₐ (6);
and
LiₓNi_{1-y-z}Mn_{y}M_{z}O₂₋ₐXₐ (7)
wherein 0.90≦x≦1.1, 0≦y≦0.5, 0≦z≦0.5, and 0≦a≦2;
M is selected from the group consisting of Al, Ni, Co, Mn, Cr, Fe, Mg, Sr, V, rare-earth elements and combinations thereof;
A is selected from the group consisting of O, F, S, and P; and
X is selected from the group consisting of F, S, and P.

17. A positive electrode for a lithium secondary battery, comprising:
a positive active material prepared through a wet process; and
a conductive agent comprising a plurality of plate-structured particles.

18. The positive electrode as recited in claim 17, wherein the positive active material is one of:
a nickel-based positive active material selected from the group consisting of compounds of formulae (1) to (7):
LiₓNi_{1-y}M_{y}A₂ (1);
LiₓNi_{1-y}M_{y}O_{2-z}X_{z} (2);
LiₓNi_{1-y}Co_{y}O_{2-z}X_{z} (3);
LiₓNi_{1-y-z}Co_{y}M_{z}Aₐ (4);
LiₓNi_{1-y-z}Co_{y}M_{z}O₂₋ₐXₐ (5);
LiₓNi_{1-y-z}Mn_{y}M_{z}Aₐ (6);
and
LiₓNi_{1-y-z}Mn_{y}M_{z}O₂₋ₐXₐ (7)
wherein 0.90≦x≦1.1, 0≦y≦0.5, 0≦z≦0.5, and 0≦a≦2;
M is selected from the group consisting of Al, Ni, Co, Mn, Cr, Fe, Mg, Sr, V, rare-earth elements and combinations thereof;
A is selected from the group consisting of O, F, S, and P; and
X is selected from the group consisting of F, S, and P, or
a manganese-based positive active material selected from the group consisting of compounds of formulae (8) to (12):
LiₓMn_{1-y}M_{y}A₂ (8);
LiₓMn_{1-y}M_{y}O_{2-z}X_{z} (9);
LiₓMn₂O_{4-z}X_{z} (10);
LiₓCo_{1-y}M_{y}A₂ (11);
and
LiₓCo_{1-y}M_{y}O_{2-z}X_{z} (12)
wherein 0.90≦x≦1.1, 0≦y≦0.5, 0≦z≦0.5, and 0≦a≦2;
M is selected from the group consisting of Al, Ni, Co, Mn, Cr, Fe, Mg, Sr, V, rare-earth elements and combinations thereof;
A is selected from the group consisting of O, F, S, and P; and
X is selected from the group consisting of F, S, and P.
